(19) United States
(12) Patent Application Publication
(10) Pub. No.: US 2010/0248746 A1
(43) Pub. Date: Sep. 30, 2010

(54) PREDICTIVE SEARCH WITH LOCATION-BASED APPLICATION

(76) Inventors: Rafael Saavedra, Sunnyvale, CA (US); Edwin Navarrete, Bogota (CO)

Correspondence Address: FENWICK & WEST LLP, SILICON VALLEY CENTER, 801 CALIFORNIA STREET, MOUNTAIN VIEW, CA, 94041, US

(21) Appl. No.: 12/749,425

(22) Filed: Mar. 29, 2010

Related U.S. Application Data
(60) Provisional application No. 61/164,801, filed on Mar. 30, 2009.

(51) Int. Cl. H04W 4/02

(52) U.S. Cl. 455/456.3

(57) ABSTRACT

A system and method are disclosed for rendering geographically and/or temporally relevant POI information on a mobile client device. A mobile device client transmits its current location to a server. The server determines and transmits to mobile client device geographically and/or temporally relevant POI information based on the received current location of the mobile client device and its predicted future locations. The mobile client device renders the received POI information when it becomes geographically relevant.

### CROSS-REFERENCE TO RELATED APPLICATION

This application claims the benefit of U.S. Provisional Application No. 61/164,801 filed Mar. 30, 2009, which is hereby incorporated by reference in its entirety.

### BACKGROUND

1. Field of Art

The disclosure generally relates to the field of location tracking, and more specifically, to providing relevant user generated data to a client in a format that is sensitive to driving demands on a driving user.

2. Description of the Related Art

Global positioning system (GPS) devices are now ubiquitous. As the technology become more affordable, the GPS device is becoming an integral part of a vehicle. The GPS devices, however, can have complex maps with a variety of options. While these maps and options can be helpful to the user, the client device can also become a distraction for a driver and divert the drivers from their driving responsibilities.

By way of example, studies have shown that a driver driving at 30 kmph can safely look at a navigation device for a maximum of 4.2 seconds to extract information from the device. Additionally, such studies have observed that a driver can read an average of only eleven roman characters per second.

Accordingly, a GPS device with complex maps can cause hazardous distraction when the drivers repeatedly search for directions and other options on the client device. For example, a driver driving down a calculated route will have to enter new information in the GPS device if the driver takes a detour from the calculated route. Moreover, if the driver wants additional information like traffic information for a detour, the driver has to select additional options on the GPS device. The driver has to either stop and enter all this new information or, more problematically, the driver enters all this new information while driving, and therefore, diverts attention from the road.

Further, the searched information may not be the most updated and most relevant information. Many GPS devices have map data that is a few years old and even if the GPS device can be updated with newer map data, the updates are not provided frequently enough. For example, a GPS device may have information about a coffee shop that was established years ago. An update may provide information that the coffee shop turned into a pizza place a year back but the updates are not provided frequently enough to warn the user that the pizza place turned into a beauty salon last week. A user looking for a slice of pizza would be unsatisfied to drive twenty miles only to learn that the beauty salon does not offer pizza slices.

### BRIEF DESCRIPTION OF DRAWINGS

The disclosed embodiments have other advantages and features which will be more readily apparent from the detailed description, the appended claims, and the accompanying drawings, in which:

FIG. 1 illustrates one embodiment of system that delivers temporally and/or geographically relevant POI information to a client device.

FIG. 2 illustrates one embodiment of architecture of a server that helps generate and deliver temporally and/or geographically relevant POI information to a client device.

FIG. 3 illustrates one embodiment of architecture of a mobile client device that receives temporally and/or geographically relevant POI information.

FIG. 4A illustrates one embodiment of a method for determining points of interest based on current location of the mobile client device and transmitting to the mobile client device POI information about the determined points of interest.

FIG. 4B illustrates one embodiment of a method for receiving and displaying temporally and/or geographically relevant POI information on the mobile client device.

FIG. 5A illustrates one embodiment of a graphical representation of the mobile client device located on a road network map.

FIG. 5B illustrates one embodiment of a graphical representation of potential routes or the location prediction tree for mobile client device on a road network map.

FIG. 5C illustrates one embodiment of a graphical representation of search space based on potential routes.

FIG. 5D illustrates one embodiment of a graphical representation of an updated search space with additional points of interest as the current location of mobile device changes.

FIG. 6 illustrates examples of user interface screens available on mobile client device for communicating information to and from a user of mobile client device.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles disclosed herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of the disclosed system and method includes a mobile client and server for generating and/or serving location specific information like multimedia or textual notes about points of interest (also referred to as “POI information”) that is made available to the users when the POI information become temporally and/or geographically relevant for the user. Examples of POI information include, but are not limited to, note with information about a traffic incident, note about an entertainment event, user “shouts” or comments about a location, note about a friend's location, or a “check-in” note describing the latest location of a friend.

POI information is geographically relevant to the user if a location associated with the POI information is within a predetermined vicinity of the location of the user's mobile device or within a predetermined vicinity of a location for which the POI information is requested or desired. In another embodiment, POI information is geographically relevant if the POI information is associated with a geographical property wherein the geographical property indicates a location that is within a predetermined vicinity of a location for which the POI information is requested or desired.

POI information is temporally relevant to the user if the POI information was created or updated within a predetermined amount of time before the POI information is requested or desired. In another embodiment, POI information is temporally relevant if the POI information is associated with a temporal property wherein the temporal property indicates a time that is within a predetermined amount of time before the POI information is requested or desired.

Users can enter search criteria on their mobile client device and the mobile client device transmits the search criteria and its current location to the server or the user may not enter a search criteria and the server uses a default search criteria to determine the relevant POI information. The mobile client device continually transmits its current location to the server as the mobile client device moves and its current location changes.

The server receives the changing current location of the mobile client device and determines the geographically relevant POI information that has associated location coordinates in vicinity of the current location of the mobile client device. The server transmits the determined POI information to the mobile client device and the mobile client device renders the POI information for the user once the mobile client device comes within a predetermined distance of the location coordinates associated with the POI information. In one embodiment, the server initially transmits a thin layer of metadata associated with the determined POI information and later transmits the thick layer once the POI information is more likely to be rendered by the client. In one embodiment, the POI information becomes more likely to be rendered as the user approaches the geographical location associated with the POI information.

In one embodiment, the server also determines the temporal relevance of the POI information before transmitting the POI information to the mobile client device. If the POI information was created or updated within a predetermined duration of searching for the POI information, the server transmits the POI information to the mobile client device. Otherwise, the server does not transmit the POI information to the mobile client device.

### Example Network

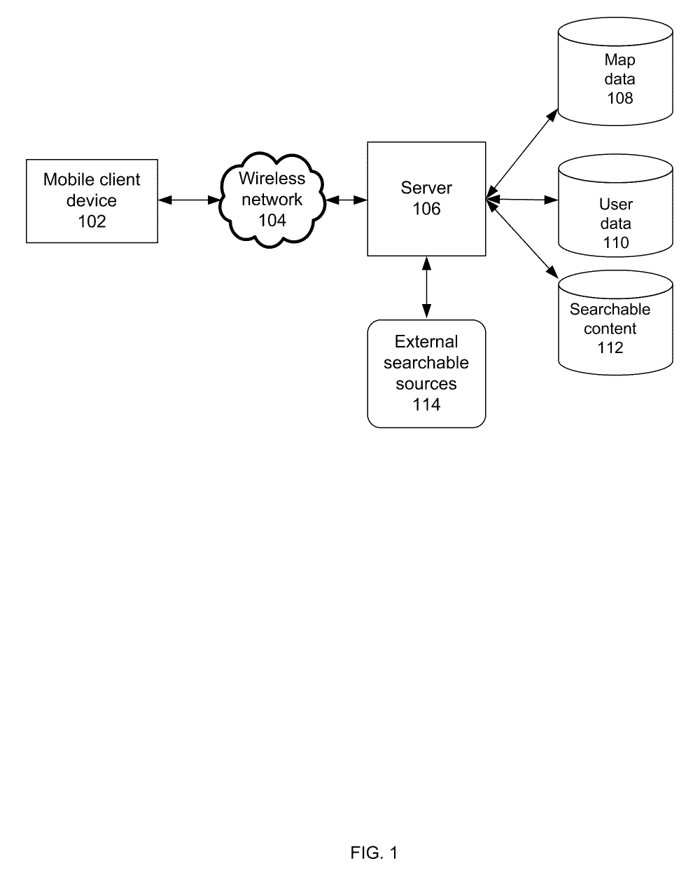

FIG. 1 illustrates one embodiment of a system 100 that delivers temporally and/or geographically relevant POI information to a client device. The system 100 includes a mobile client device 102, a wireless network 104, a server 106, a map database 108, a user database 110, a searchable content database 112 and an external searchable source 114. The mobile client device 102 communicatively couples to server 106 through wireless network 104. The server 106 communicatively couples to external searchable source 114, map database 108, user database 110 and searchable content database 112 through wireless network 104 or another wired or wireless network.

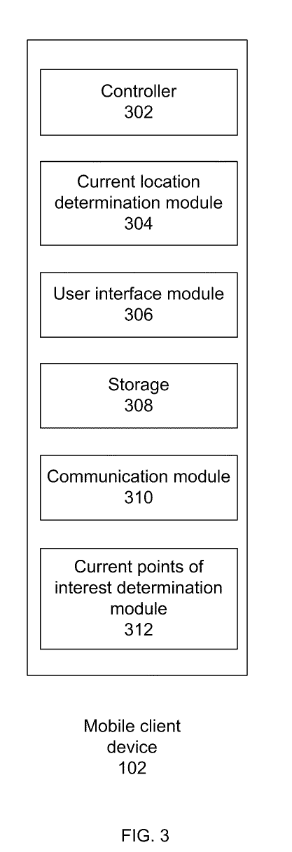

The mobile client device 102 is a hardware, software, firmware or a blended implementation that is capable of determining its geographic location and transmitting its location to server 106 through a wireless network 104. The mobile client device 102 also provides a user interface to render POI information received from server 106 for the device user. In one embodiment, the mobile client device 102 is a standalone device that performs part or all of the features disclosed in this application. In another embodiment, the mobile client device 102 is a mobile phone, a GPS device or another mobile device capable of wirelessly communicating with server 106 that implements part or all of the disclosed features in addition to other application feature. The mobile client device 102 is further explained in detail with respect to FIG. 3.

The wireless network 104 is a collection of networking devices that enables its connected entities to wirelessly communicate with each other. The wireless network can be a wireless personal area network, wireless local area network, wireless metropolitan area network or a mobile device network, for example, global system for mobile communications (GSM), personal communications service (PCS) network or digital advanced mobile phone service (D-AMPS) network.

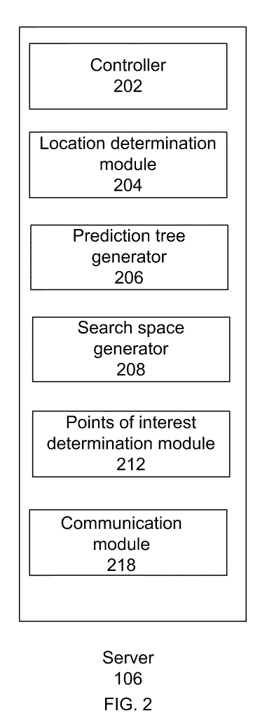

Server 106 is a hardware, software, firmware or a blended implementation that receives the location of mobile client device 102, determines the temporally and/or geographically relevant POI information for transmission to mobile client device 102 and transmits the determined POI information to mobile client device 102. Server 106 searches for relevant POI information from various databases communicatively coupled to server 106. In one embodiment, server 106 also receives and stores POI information generated by users of mobile device 102. Server 106 is described in detail in FIG. 2.

Map database 108 includes hardware, software, and/or firmware configured to implement a database that stores map data that represents a road network with associated features like points of interest. The map database comprises basic elements of road network, like nodes and connections between the nodes, and properties of those elements like location coordinates, shape, addresses, road class, speed range etc.

User database 110 includes hardware, software, and/or firmware configured to implement a database comprising information about various users of mobile client device 102. The information includes a user identification (id), name, associated groups and associated friends of a user. User database 110 can comprise additional information like user preferences, user's past search criteria and user's frequently visited points of interest.

Searchable content database 112 includes hardware, software, and/or firmware configured to implement a database comprising content searched by server 106 and transmitted to mobile client device 102. The searchable content database 112 comprise content generated by users of mobile client device 102. In one embodiment, the generated content comprises one or more from the group of POI information generated by a user, geographical coordinates associated with the POI information, a category for the POI information, a user community rating and the time the user generated the POI information.

External searchable source 114 includes hardware, software, and/or firmware configured to implement a database comprising geographically and/or temporally relevant POI information. For example, the POI information comprises audio, video or textual description associated with business listings, points of interest, locations of red light cameras, or road traffic conditions. In one embodiment, the POI information is geotagged, i.e. the POI information includes geographical identification metadata identifying the location associated with the POI information. In one embodiment, the external searchable source is an external service that provides relevant content through network 104 or a wired network.

### Example Server Architectural Overview

FIG. 2 illustrates one embodiment of architecture of a server 106. Server 106 is configured to determine the location of mobile client device 102 on a road network and transmit the mobile client device 102 information, for example temporally and/or geographically relevant POI information, based on the determined location and search criteria associated with the mobile client device 102. In one embodiment, server 106 receives or retrieves the search criteria associated with the mobile client device 102, determines resulting POI information based on the search criteria, determines the changing location of mobile client device 102, and transmits the POI information to the mobile client device 102 as it becomes temporally and/or geographically relevant to the determined location of the mobile client device 102. In another embodiment, the server 106 receives or retrieves the search criteria associated with the mobile client device 102, determines the changing location of mobile client device 102, and then determines and transmits resulting POI information associated with the current location of the mobile client device 102 and the search criteria. Additionally, in one embodiment, server 106 also generates and publishes on a web site content comprising POI information generated by user of mobile client device 102.

Server 106 comprises a controller 202, location determination module 204, prediction tree generator 206, search space generator 208, points of interest determination module 212, and communication module 218. All these modules are communicatively coupled to each other through a communication data bus.

Controller 202 is a hardware, firmware, software or blended implementation that directs other modules in server 106 to implement their respective tasks in response to an event or receiving a particular message. In one embodiment, controller 202 implements the state machine of server 106.

Location determination module 204 is a hardware, firmware, software or blended implementation that determines the location of mobile client device 102 on a road network map. In one embodiment, the location determination module 204 repeatedly receives the location coordinates of the mobile client device 102 from mobile client device 102. The location determination module 204 uses these received coordinates and, if available, its heading and speed to locate the client device 102 on a road network map.

Prediction tree generator 206 is a hardware, firmware, software or blended implementation that determines the potential routes for mobile client device 102 based on a current location of mobile client device 102 transmitted by mobile client device 102 to server 106. In one embodiment, the prediction tree generator 206 also uses the destination location to predict potential routes if the user has specified a destination location. The prediction tree generator 206 keeps updating the possible routes for a mobile client device 102 as the mobile client device moves from one location to another.

In one embodiment, the user of mobile client device 102 does not specify a destination location and the prediction tree generator searches for potential routes based on the current location of the mobile client device 102. The prediction tree generator 206 can also use information about road connections, road class, speed range, etc. from the Map data 108 to search for potential routes. In one embodiment, the prediction tree generator also uses the current heading or the current speed of the client device 102 to determine the potential routes. To determine potential routes, the prediction tree generator 206 selects from the road network map the road segments that most closely match the user's position and heading. The prediction tree generator 206 then follows the road connections from those road segments to other road segments that the user can reach in a given time limit, therefore tracing the possible paths that the user can follow in that time limit. The result of this road tracing is an ordered set of connected road segments that make up the potential routes that the user can follow. The above illustrated technique is one example of predicting potential routes and this illustrated technique is not meant to limit the prediction tree generator 206 to the illustrated technique. Instead, one of ordinary skill in the art will realize that the prediction tree generator 206 can implement various other techniques to predict potential routes. As the current location of the mobile client device 102 changes, the prediction tree generators recalculates or updates the potential routes that can be taken by a user of mobile client device 102. In another embodiment, the prediction tree generator 206 also uses information like the route traversed by the user in recent past to determine potential routes for the user.

By way of example, the user can enter search criteria and start moving with the mobile client device 102. The prediction tree generator 206 determines potential routes for the moving mobile client device 102 based on whether the user is on a highway or another road, speed and heading of the mobile client device, and how long the user has been travelling in a particular direction. If the user has been on a highway for a few minutes, the user is unlikely to get off the highway for the next few minutes. The prediction tree generator takes into account these and similar factors to predict potential routes for a user.

Search space generator 208 is a hardware, firmware, software or blended implementation that uses the potential routes determined by prediction tree generator 206 and determines the search area that should be searched by points of interest determination module 212 for content of interest. In one embodiment, the search space generator 208 determines the search area by defining circles around the major intersections (for example, freeway exits or avenue crossings) within the potential routes. In this case the resulting search area is a set of circular areas that can be used by the content of interest determination module 212 as search space to search for content of interest. The above illustrated technique is one example of determining a search space and this illustrated technique is not meant to limit the search space generator 208 to the illustrated technique. Instead, one of ordinary skill in the art will realize that the search space generator 208 can implement various other techniques to determine a search space.

Points of interest determination module 212 is a hardware, firmware, software or blended implementation that searches map database 108, searchable content database 112 and external searchable source 114 to determine the points of interest and its associated POI information for a particular user of mobile computing device 102. The points of interest determination module 212 uses a default search criteria or a search criteria provided by user of mobile client device 102 to determine the points of interest within the search area provided by the search space generator 208. The default search criteria can comprise restaurants, gas stations, rest areas and traffic conditions on a predicted route.

Communication module 218 is a hardware, firmware, software or blended implementation that provides a communication channel for various modules in server 106 to communicate with other entities in system 100. The communication module 218 communicatively couples to mobile client device 102, external searchable source 114, map database 108, user database 110 and searchable content database 112.

### Example Client Architectural Overview

FIG. 3 illustrates one embodiment of architecture of mobile client device 102. Mobile client device 102 is responsible for transmitting to server 106 its current location and search criteria specified by a user. In one embodiment, the mobile client device 102 also receives temporally and/or geographically relevant POI information from server 106 and renders the appropriate POI information for the user.

Mobile client device 102 comprises a controller 302, a current location determination module 304, a communication module 310, a storage module 308, a user interface module 306 and a current point of interest determination module 312. The modules are communicatively coupled to each other through a communication bus.

Controller 302 is a hardware, firmware, software or blended implementation that directs other modules in mobile client device 102 to implement their respective tasks in response to an event or receiving a particular message. In one embodiment, controller 302 implements the state machine of mobile client device 102.

The current location determination module 304 is a hardware, firmware, software or blended implementation that determines the current coordinates of mobile client device 102. In one embodiment, the current location determination module 304 communicatively couples to one or more satellites in a global positioning system (GPS). The current location determination module 304 determines the location of mobile client device 102 by communicating with these satellites. The method for determining a current location with the help of a GPS is well known in the art. In another embodiment, the current location determination module 304 communicatively couples to a GPS device and determines the current location of mobile client device 102 through the GPS device. In one embodiment, the current location determination module 304 also determines the speed and heading direction of client 102 through the GPS device or by communicating with GPS satellites.

The current location determination module 304 can also use various other methods like cellular, Wi-Fi, other position determination technology, or a combination of these technologies to determine the current location of the mobile client device 102.

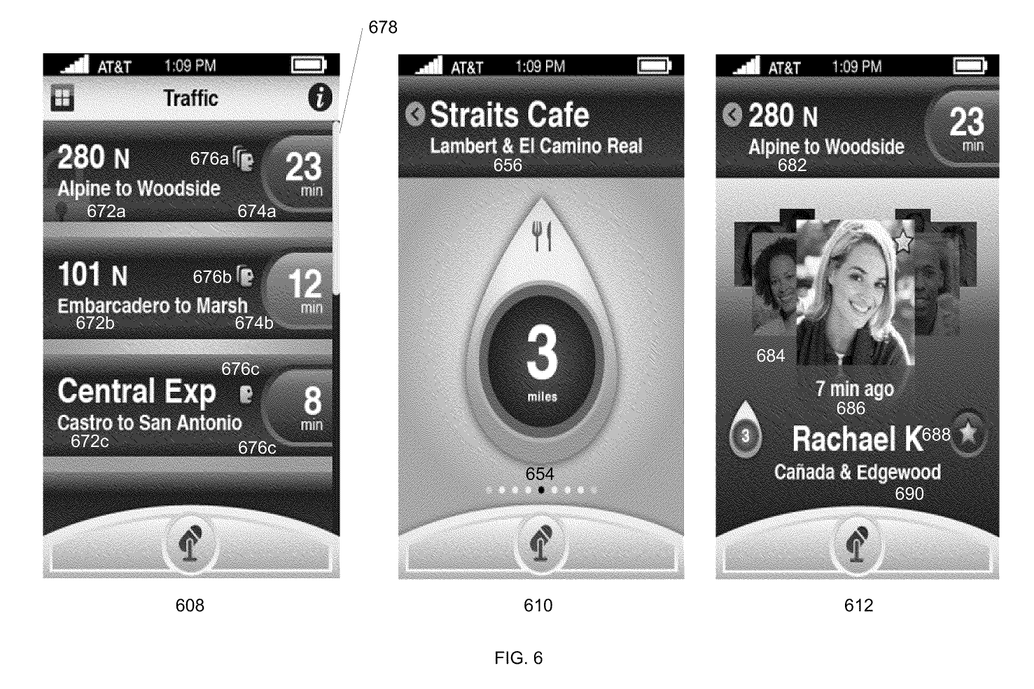

The user interface module 306 is a hardware, firmware, software or blended implementation that controls the user interface that renders the temporally and/or geographically relevant POI information received from server 106. In one embodiment, the user interface module 306 also controls user interface that allows the users to enter their search criteria and destination location. Examples of user interface screens available on the mobile client device are explained below with respect to FIG. 6.

The current points of interest determination module 312 is a hardware, firmware, software or blended implementation that receives potential points of interest from server 106 through communication module 310, receives current location of the mobile client device from current location determination module 304 and determines from the potential points of interest the current points of interest that have some relevancy to the user's current location, for example geographical and/or temporal relevancy to the user's current location. In one embodiment, the current points of interest determination module 312 does not determine such relevancy and deems the potential points of interest as the current points of interest.

In one embodiment, the current points of interest determination module 312 after determining the current points of interests requests from server 106 a thick layer of information. In another embodiment, the server 106 transmits the thick layers without receiving a request from the current points of interest determination module 312. A thick layer of information includes, for example, additional information regarding the current points of interest. The additional information can comprise user generated information like user generated POI information associated with the points of interest. For example, the additional information can comprise of users' YELP comments regarding the points of interest extracted from the YELP website. One of ordinary skill in the art upon reading this disclosure will understand that information about a point of interest can be requested in multiple layers and the information transmitted in different layers may be divided differently in various layers as compared to the disclosed division of information amongst the thin layer and thick layer.

Storage 308 is a hardware, firmware, software or blended implementation that stores information used by other modules in mobile client device 102. For example, storage 308 stores temporally and/or geographically relevant POI information received by communication module 310 from server 106. In one embodiment, storage 308 also stores the user interface screens that are either received from server 106 or are preconfigured into mobile client device 102.

Communication module 310 is a hardware, firmware, software or blended implementation that provides a communication channel for various modules in mobile client device 102 to communicate with other entities in system 100. The communication module 310 is communicatively coupled to server 106.

### Example User Interface

Turning now to FIG. 6, it illustrates examples of user interface screens 608-612 available on mobile client device 102 for communicating information to and from a user of mobile client device 102. Screen 608 displays various results of a default search criteria or a user specified search criteria. The user can scroll down for more results through scroll bar 678. Each result displays a description 672a-c of the proposed routes and the amount of time 674a-c estimated to reach the destination through the proposed routes. Screen 608 also comprises an additional information available icon 676a-c. The user can select this icon 676a-c to access the additional information like POI information associated with points of interest on the proposed routes. In one embodiment, the user selects icon 676a and the additional POI information associated with route 280N is rendered for the user in a sequence. In another embodiment, the additional POI information associated with locations closest to the location of mobile client device 102 is rendered and the POI information associated with other locations is rendered once the user selects the route and approaches the associated locations. In yet another embodiment, additional POI information for a selected route is rendered for the user as it becomes available.

Screen 610 displays temporally and/or geographically relevant POI information received from server 106 in response to a default search criteria or a user specified search criteria. In this example, the result is a restaurant on Lambert & El Camino Real that is 3 miles straight ahead. Section 656 displays the name of the restaurant and the intersection where the restaurant is located. Pointer 654 displays that restaurant is straight ahead and 3 miles away.

In one embodiment, selection of icon 676a-c on screen 608 leads the user to screen 612. Screen 612 comprises information 682 about the selected route, a menu 684 listing user generated POI information, user information 688 for the user that generated the POI information, the temporal relevance 686 of the POI information and the geographical relevance 690 of the POI information. Information 682 describes the route selected by a user.

Menu 684 includes a list of user generated POI information. In one embodiment, the user generated POI information is organized by the users who generated the POI information. In another embodiment, the user generated POI information is organized by temporal relevance or geographical relevance.

Temporal relevance 686 includes information regarding the temporal characteristic of the generated POI information. For example, the temporal relevance 686 can include information about the time when the POI information was generated, the amount of time passed since the POI information was confirmed by another user or the last time the POI information was updated.

Geographical relevance 690 includes information about the geographical characteristics of the POI information. For example, geographical relevance can include an intersection, a point of interest or a well known signpost in the neighborhood associated with the POI information.

User information 688 includes information about the user who generated the POI information. In one embodiment, the information comprises a generator's name, a generator's picture, alias or a group that includes the generator.

### Determining and Transmitting Points of Interest

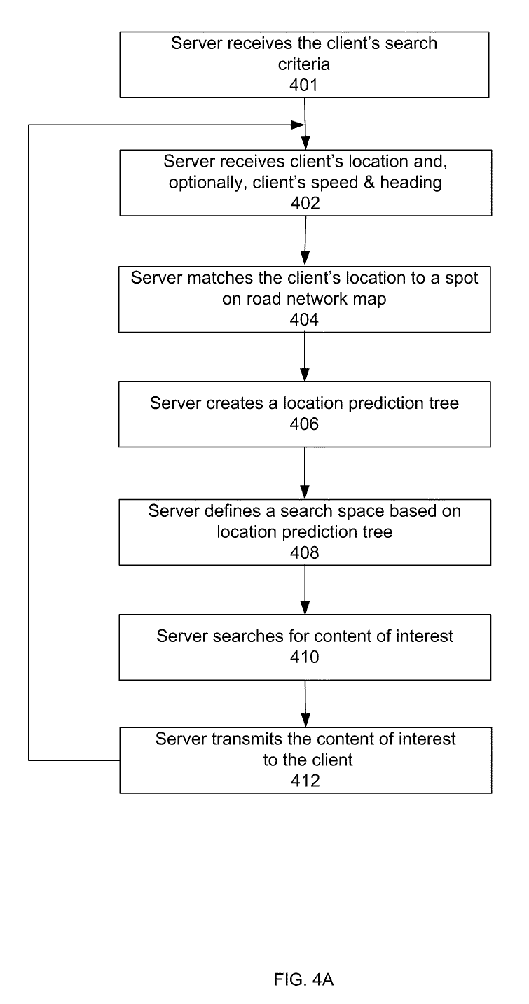

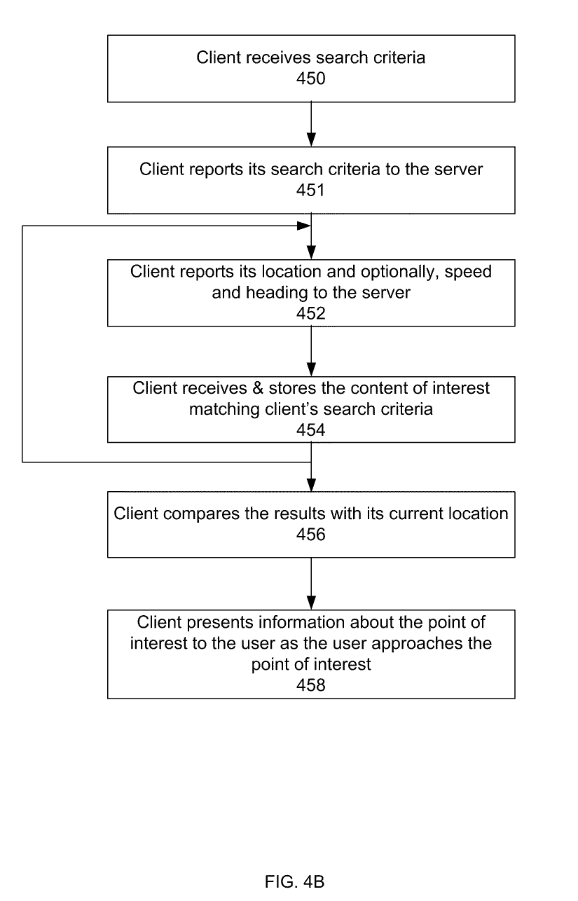

Turning now to FIG. 4A, it illustrates one embodiment of a method for determining points of interest based on current location of the mobile client device 102 and/or search criteria transmitted from mobile client device 102 to server 106. The communication module 218 at server 106 receives 402 the current location coordinates of mobile client device 102 through communication module 310 at mobile client device 102. The communication module 218 forwards the received location coordinates to location determination module 204. In one embodiment, the communication module 218 also receives a destination location from mobile client device 102 and the communication module 218 forwards the destination location to prediction tree generator 206.

Additionally, the communication module 218 receives a 401 search criteria specified by a user of the mobile client device 102. In one embodiment, the received search criteria are default search criteria, and not user specified search criteria, located at mobile client device 102. In one embodiment, server 106 does not receive a search criteria and server 106 uses a default search criteria stored in user database 110, search space generator 208 or another module in server 106. Regardless of how communication module 218 receives the search criteria, the communication module 218 forwards the search criteria to search space generator 208.

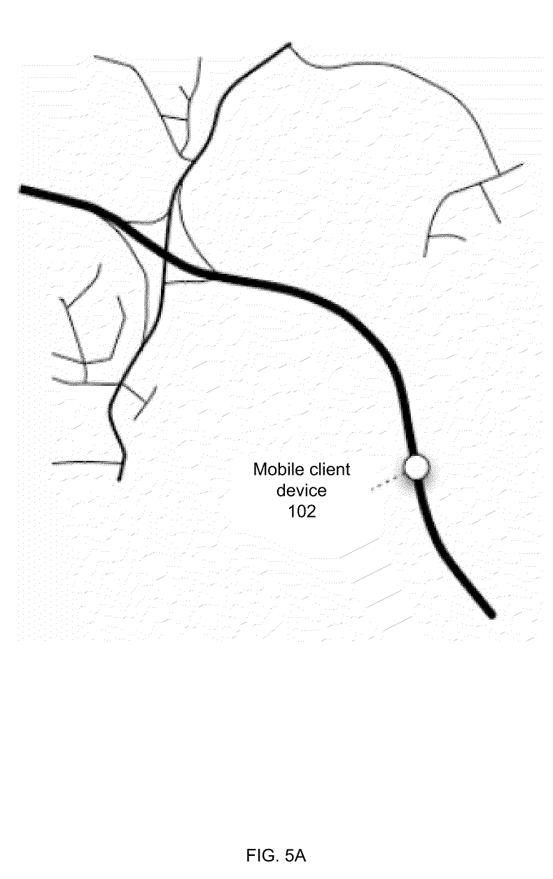

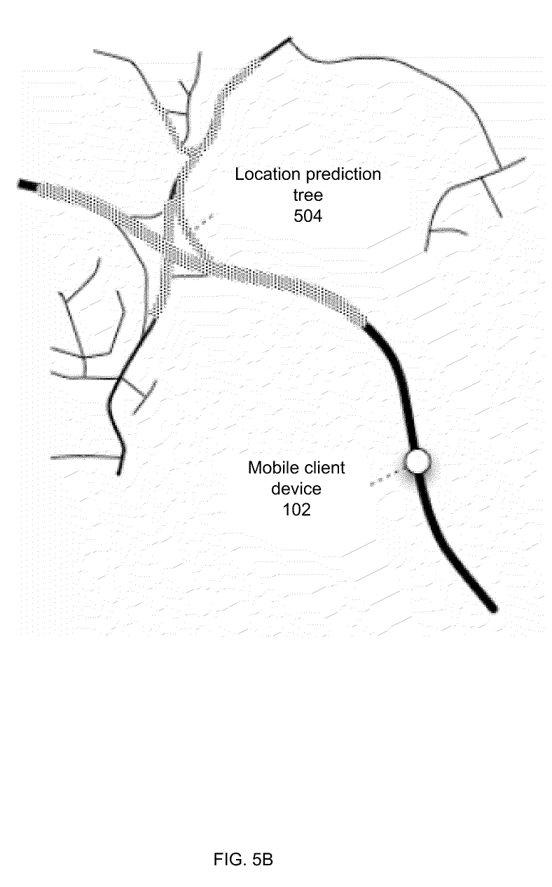

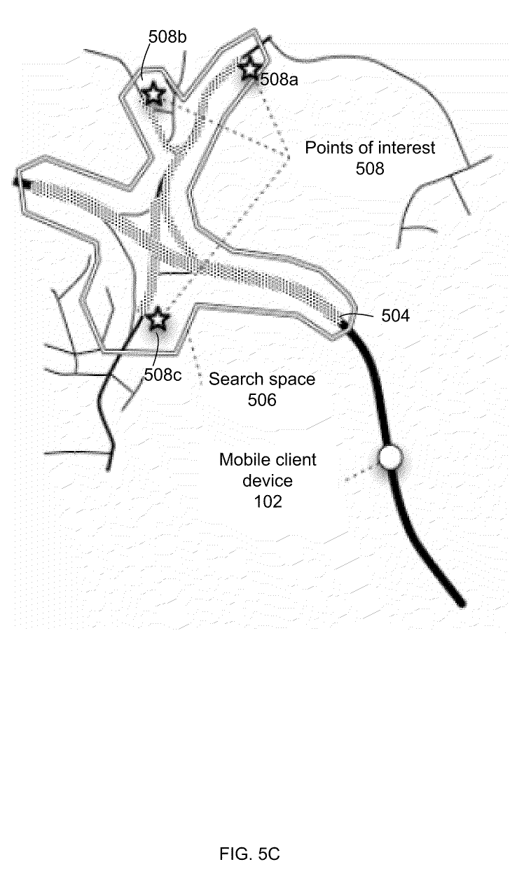

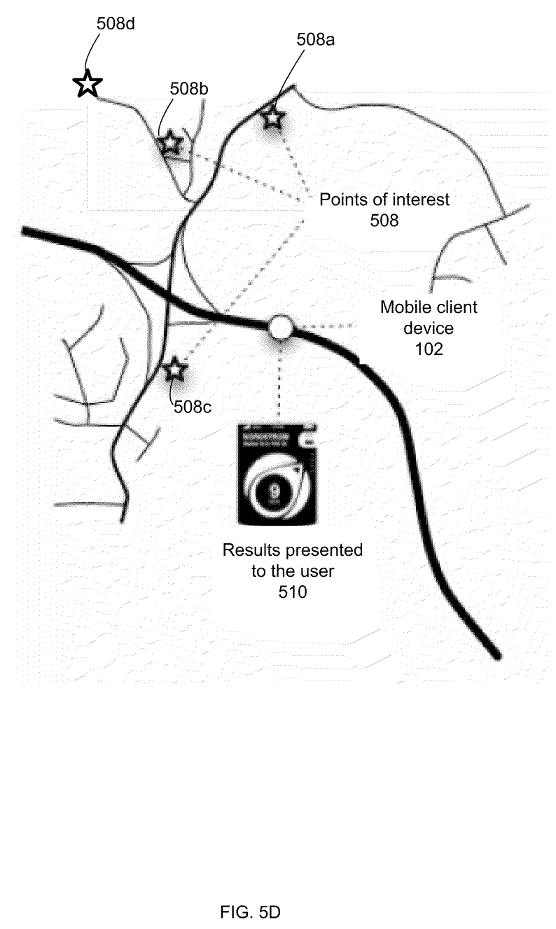

Next, the location determination module 204 locates 404 the received coordinates on a road network map. FIG. 5A illustrates a graphical representation of the mobile client device 102 located on a road network map.

The prediction tree generator 206 then determines 406 the potential routes for mobile client device 102 based on the determined location of mobile client device 102 on road network map. In one embodiment, the prediction tree generator 206 also uses the destination location, heading direction or speed of mobile client device 102 to determine 406 the potential routes for mobile client device 102. FIG. 5B illustrates a graphical representation of potential routes or the location prediction tree 504 for mobile client device 102 on a road network map.

The search space generator 208 then uses the potential routes 504 to determine 408 the search space based on the potential routes 504. FIG. 5C illustrates a graphical representation of search space 506 based on potential routes 504.

After the search space generator 208 has created search space 506, the points of interest determination module 212 determines 410 the points of interest and/or POI information with associated location coordinates that fall within search space 506 and meet the requisites of search criteria. Points of interest 508a-c (508 collectively) represent the determined points of interest in FIG. 5C. The determined points of interest 508 and/or POI information is then transmitted 480 to mobile client device 102.

In one embodiment, POI information and/or related information associated with a point of interest can be transmitted in multiple layers. For example, server 106 can initially transmit a thin layer comprising information about the point of interest like its name, type, and the last time a user left POI information about the point of interest. The server 106 can later transmit a thick layer comprising the POI information associated with that point of interest. In one embodiment, server 106 transmits the thick layer as the mobile client device 102 approaches the location associated with the POI information. The mobile client device 102 receives the transmitted potential points of interest and stores 454 the potential points of interest in storage 308.

In one embodiment, server 106 repeatedly, eg. every predetermined interval based on time or distance, receives the changing current location of mobile client device 102. As the changing current location is received, the server 106 repeats steps 402-412 for various current locations of mobile client device 102. In another embodiment, server 106 repeats steps 402-412 periodically or repeatedly as additional POI information about the points of interest 508 is generated by other users. FIG. 5D illustrates the result of repeated steps 402-412 as the current location of mobile device 102 changes. As the mobile device 102 moves up on a road, additional points of interest like point of interest 508d become available and are transmitted to mobile device 102.

The disclosed embodiments beneficially include a server configuration to predict potential routes for a user and potential points of interest that meet a user specified search criteria or a default search criteria. Users receive the points of interest on their route as they drive around without entering a destination or an endpoint for their route and without having to manually start a search while driving, a method that usually provides results that are already behind and diverts attention from the road. Unlike a conventional local search that requires a location parameter to search for various things in a locale, the disclosed embodiments allow users to enter search criteria without any location parameters. The users therefore are not limited by planning their location destination before starting their route. The users can drive without specifying a destination address, and the disclosed embodiments predict potential routes and transmit in advance potential points of interest to the users' mobile client device. As the user approaches the point of interest, POI information about the point of interest is rendered for the user.

Additionally, the POI information transmitted by server 106 to client 102 informs the user of any recent changes to the point of interest. For example, the POI information for a business can comprise a note from another user informing everyone that the business has moved its location. The user therefore can get updated information about a point of interest that is a lot more recent than updates provided by GPS providers.

FIG. 4B illustrates a method for receiving and displaying temporally and/or geographically relevant points of interest on mobile client device 102. The user interface module 306 on mobile client device 102 receives 450 a search criteria from the user. The search criteria comprise user preferences for a route. For example, a user can specify search criteria that determine grocery stores on the way to an unknown destination. The user in this case does not specify a destination and expects the mobile client device 102 to render information about grocery stores that are in proximity of the user's changing location as the user drives around.

The user interface module 306 stores the search criteria in storage 308 and informs controller 302 about the received search criteria. The controller 302 retrieves the search criteria from storage 308 and transmits 451 the search criteria to server 106 through communication module 310. In one embodiment, the server 106 stores the received search criteria for later use in the user database 110 and server 106 can use the stored search criteria for later instances until the user specifies new search criteria. In another embodiment, the user does not specify search criteria and server 106 uses a default search criteria instead of a user defined search criteria. In yet another embodiment, server 106 develops search criteria specific to a particular user of mobile device 102 based on the user's previous searches and other uses of the mobile device 102 or user preferences extracted from an external source.

The controller 302 then retrieves the current location of mobile client device 102 from current location module 304 or storage 308. In one embodiment, controller 302 also retrieves speed and the heading direction from current location determination module 304 or storage 308. The controller then transmits 452 the retrieved information to server 106 through communication module 310.

As discussed above, the server 106 determines and transmits to mobile client device 102 the potential points of interest based on location of mobile client device 102 and the received or default search criteria. The mobile client device 102 receives and stores 452 the transmitted potential points of interests.

Steps 452 and 454 are repeated several times as the current location of mobile client device 102 changes. In one embodiment, the mobile client device 102 receives additional POI information about a point of interest from server 106 as additional POI information matching the user's search criteria is generated by other users or additional points of interest match the search criteria and changed location of mobile client device 102. In another embodiment, the mobile client device 102 keeps receiving additional POI information as the current location of the moving mobile client device 102 keeps changing.

The current location determination module 304 keeps track of the changing location of mobile client device 102 and controller 302 keeps comparing 456 the changing current location of mobile client device 102 with location coordinates associated with stored potential content of interest. If the changing current location of mobile client device 102 comes in a predetermined vicinity of location coordinates associated with a stored potential point of interest, controller 302 determines that the point of interest is geographically relevant and renders the potential content of interest through user interface module 306 for the user. In one embodiment, controller 302 requests server 106 for the thick layer once the mobile client device 102 comes in a predetermined vicinity of location coordinates associated with the point of interest, receives and then renders 458 the information from the thick layer with the name and type of the point of interest.

In one embodiment, controller 302 also determines the temporal relevance of the POI information associated with the point of interest before rendering the POI information for a user. Controller 302 therefore searches the metadata associated with the POI information to determine if the POI information was created or updated before a predetermined time duration. If not, controller 302 determines that the POI information is temporally relevant and renders the POI information for the user. Otherwise, controller 302 does not render the POI information.

Some portions of above description describe the embodiments of the invention in terms of algorithms and symbolic representations of operations on information, for example, the processes described with respect to FIGS. 4A-4B including reference to FIGS. 5A-5D and FIG. 6. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

The description about the mobile client device 102, the server 106 assigns particular functions to one entity or a component in the entity. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component of the mobile client device 102 or the server 106 can be performed by different or multiple components operating together, as deemed appropriate by the implementer.

Upon reading this disclosure, those of skill in the art will appreciate still additional alternative structural and functional designs for a system and a process for predicting and rendering information about temporally and/or geographically relevant points of interest through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An apparatus for persistently determining predictive search results for display on a moving mobile client, the apparatus comprising:
a communication module for persistently receiving a current location of the moving mobile client;
a location determination module, communicatively coupled to the communication module, for persistently locating the moving mobile client relative to a road network map based on the received current location;
a prediction tree generator, communicatively coupled to the location determination module, for persistently predicting a plurality of routes that can be traversed by the moving mobile client on the road network map, the plurality of predicted routes re-predicted responsive to a change in the current location of the moving mobile client; and
a point of interest determination module, communicatively coupled to the prediction tree generator, for persistently determining a plurality of points of interest on the plurality of predicted routes based on a search criteria associated with the moving mobile client.

2. The apparatus of claim 1, wherein:
the communication module further receives one of a speed of the moving mobile client and a heading of the moving mobile client; and
the prediction tree generator uses one of the speed and the heading to predict the plurality of routes.

3. The apparatus of claim 1, further comprising:
a search space generator for generating a search space based on the plurality of predicted routes wherein the point of interest determination module searches the plurality of predicted routes within the search space to determine the plurality of points of interest.

4. The apparatus of claim 3, wherein the search space comprises circles around major intersections within the plurality of predicted routes.

5. The apparatus of claim 1, wherein the communication module transmits to the moving mobile client an initial thin layer and a later thick layer of information about the determined plurality of points of interest, the thin layer comprising a name and a location information about the determined plurality of points of interest, the thick layer comprising user generated POI information about the determined plurality of points of interest.

6. An apparatus for displaying directions to currently relevant points of interest on a moving mobile client, the apparatus comprising:
a communication module for persistently transmitting to a server a current location of the mobile client, and for persistently receiving a plurality of points of interest from the server wherein the plurality of points of interest are based on a search criteria associated with the moving mobile client and the plurality of points of interest are located on a plurality of potential routes predicted to be traversed by the mobile client;
a storage module for storing the received plurality of points of interest; and
a current points of interest determination module, communicatively coupled to the storage module, for persistently determining a current point of interest from the stored plurality of points of interest.

7. The apparatus of claim 6, wherein the current points of interest determination module persistently determines the current point of interest based on a changed current location of the mobile client.

8. The apparatus of claim 6, wherein the communication module receives from the server an initial thin layer and a later thick layer of information about the plurality of points of interest, the thin layer comprising a name and a location information about the plurality of points of interest, the thick layer comprising user generated POI information about the plurality of points of interest.

9. The apparatus of claim 6, wherein the communication module further transmits to the server one from a speed of the mobile client and a heading of the mobile client, and the one of the speed and the heading is used by the server to determine the plurality of points of interest.

10. The apparatus of claim 6, further comprising:
a user interface module for communicating to a user directions for the determined current point of interest.

11. A method for displaying directions to currently relevant points of interest on a moving mobile client, the method comprising:
persistently receiving a current location of the moving mobile client;
persistently locating the moving mobile client on a road network map based on the received current location;
persistently predicting, based on the persistently received current location, a plurality of routes that can be traversed by the moving mobile client on the road network map wherein the plurality of predicted routes change with a change in the current location of the moving mobile client;
persistently determining a plurality of points of interest on the plurality of predicted routes.

12. The method of claim 11, further comprising:
receiving one from a speed of the moving mobile client and a heading of the moving mobile client; and
wherein the plurality of routes are predicted based on the received one of the speed and the heading.

13. The method of claim 11, further comprising:
generating a search space based on the plurality of predicted routes wherein the plurality of determined points of interest are located within the search space and on the predicted plurality of routes.

14. The method of claim 13, wherein the search space comprises circles around the major intersections within the plurality of predicted routes.

15. The method of claim 11, further comprising:
transmitting to the moving mobile client an initial thin layer and a later thick layer of information about the determined plurality of points of interest, the thin layer comprising a name and a location information about the determined plurality of points of interest, the thick layer comprising user generated POI information about the determined plurality of points of interest.

16. A method for displaying directions to currently relevant points of interest on a moving mobile client, the method comprising:
persistently transmitting to a server a current location of the moving mobile client;
persistently receiving a plurality of points of interest from the server wherein the plurality of points of interest are based on a search criteria associated with the moving mobile client and the plurality of points of interest are located on a plurality of potential routes predicted to be traversed by the mobile client;
storing the received plurality of points of interest; and
persistently determining a current point of interest from the stored plurality of points of interest.

17. The method of claim 16, wherein the persistently determined current point of interest is based on a changed current location of the mobile client.

18. The method of claim 16, further comprising:
receiving from the server an initial thin layer and a later thick layer of information about the plurality of points of interest, the thin layer comprising a name and a location information about the plurality of points of interest, the thick layer comprising user generated POI information about the plurality of points of interest.

19. The method of claim 16, further comprising:
transmitting to the server one from a speed of the mobile client and a heading of the mobile client, wherein the one of the speed and the heading is used by the server to determine the plurality of points of interest.

20. The method of claim 16, further comprising:
communicating to a user directions for the determined current point of interest.
